(19) United States
(12) Patent Application Publication
(10) Pub. No.: US 2015/0321659 A1
(43) Pub. Date: Nov. 12, 2015

(54) CONTROL DEVICE FOR HYBRID VEHICLE

(71) Applicants: Daiki SATO, (US); Masato NAKANO, (US); Masataka SUGIYAMA, (US); Taku HARADA, (US); Akihiro SATO, (US)

(72) Inventors: Daiki SATO, Toyota-shi (JP); Masato NAKANO, Toyota-shi (JP); Masataka SUGIYAMA, Toyota-shi (JP); Taku HARADA, Nisshin-shi (JP); Akihiro SATO, Nagoya-shi (JP)

(73) Assignee: TOYOTA JIDOSHA KABUSHIKI KAISHA, Toyota-shi, Aichi-ken (JP)

(21) Appl. No.: 13/982,143

(22) PCT Filed: Dec. 4, 2012
(86) PCT No.: PCT/JP2012/081393

§ 371 Date: Jul. 26, 2013

(51) Int. Cl. B60W 20/00; B60K 6/445; B60K 6/24; B60W 10/08; B60W 10/06

(52) U.S. Cl. CPC B60W 20/1084; B60W 10/08; B60W 10/06; B60K 6/24; B60K 6/445; Y10S 903/93; Y10S 903/905; B60W 2520/40; B60W 2710/0666; B60W 2710/083

(57) ABSTRACT

The control device of the present invention is applied to a vehicle in which a second motor-generator is linked to an output gear train via a gear. This control device sets a lower limit value for the torque outputted by the second motor-generator when a first motor-generator is locked by a motor locking mechanism and a power split mechanism is put into a non-differential state, and controls the second motor-generator so that, when the power split mechanism is in the non-differential state, the magnitude of the torque outputted by the second motor-generator is at least equal to the magnitude of that lower limit value.

### TECHNICAL FIELD

The present invention relates to a control device applied to a hybrid vehicle that has two sources of power for driving, an engine and an electric motor.

### BACKGROUND ART

A hybrid vehicle is well known in which the power of an internal combustion engine is divided between a first electric motor and an output unit, and a second electric motor is linked to the output unit via a gear. In a hybrid vehicle of this type, when the torque of the second electric motor is in the vicinity of 0 Nm, the pressure against the output unit of a gear that is interposed between the output unit and the second electric motor becomes eased. As a result, due to transmission of rotational fluctuations of the engine, the output unit and the gear mutually clash together in a backlash, and gear rattle noise is generated. Thus a control device has been proposed (refer to Patent Document #1) in which, in order to suppress this gear rattle noise, when the torque of the second electric motor is within a predetermined range that includes zero, rotational fluctuations of the engine are decreased by changing the operating point of the engine towards the high rotational speed side.

### CITATION LIST

### Patent Literature

### Patent Document #1: Japanese Laid-Open Patent Publication 2010-179856.

### SUMMARY OF THE INVENTION

### Technical Problem

As one method for changing the operating point of the engine, there is a method of changing over the functioning of the differential mechanism that divides the power of the engine to a non-differential state in which this differentiating function is stopped, and this is done by fixating some rotating element to which the first electric motor is linked, or the like. When the operating point of the engine is changed by this method, since the power from the engine is then transmitted to the output unit without any of that power being allocated to the first electric motor, accordingly the engine rotational speed and the vehicle speed correspond one-to-one. Thus, since changing of the operating point of the engine is limited by the vehicle speed when the differential mechanism is changed over to the non-differential state, accordingly it is not possible to change the operating point of the engine while keeping the same power output. Due to this, when the differential mechanism is not differentiating, it is necessary to supplement any shortage of the required drive force with torque that is outputted by the second electric motor. In a situation when the greater portion of the required drive force is being covered by the engine torque, the torque to be outputted by the second electric motor becomes quite low. As a result, it could happen that the torque of the second electric motor may enter into the range described above in which the gear rattle noise is generated, so that it becomes impossible to suppress the gear rattle noise.

Thus, it is an object of the present invention to provide a control device for a hybrid vehicle that is capable of suppressing gear rattle noise that may occur when a differential mechanism is in the non-differential state.

### Means for Solution

A control device as one aspect of the present invention is a control device for a hybrid vehicle comprising: an engine; a first motor-generator; an output unit for transmitting torque to drive wheels; a differential mechanism that distributes torque of said engine to said first motor-generator and to said output unit; a locking device that is capable of changing over a state of said differential mechanism from a differential state in which the torque of said engine is distributed to said first motor-generator and to said output unit, to a non-differential state in which this distribution is stopped; and a second motor-generator that is linked to said output unit via a gear, the control device comprising; a torque lower limit value setting device configured to, when said differential mechanism is in said non-differential state, set a lower limit value for torque to be outputted by said second motor-generator; and a motor control device configured to, when said differential mechanism is in said non-differential state, control said second motor-generator so that magnitude of the torque outputted by said second motor-generator becomes greater than or equal to magnitude of said lower limit value.

Since, according to this control device, the magnitude of the torque outputted by the second motor-generator is controlled to be greater than or equal to the magnitude of the lower limit value when the differential mechanism is in its non-differentiating state, accordingly the state is maintained in which the gear that is interposed between the second motor-generator and the output unit, and the output unit, are mutually pressed together. Thus, it is possible to suppress gear rattle noise generated by this gear and the output unit mutually colliding together due in a backlash.

In one embodiment of the control device the present invention, said engine may have a plurality of cylinders, and is configured to perform partial cylinder operation in which some of said plurality of cylinders are inactive while the remaining ones of said plurality of cylinders operate, and all-cylinder operation in which all of said plurality of cylinders operate; the control device may further comprise an engine control device configured to cause said engine to execute either said partial cylinder operation or said all-cylinder operation; and wherein said torque lower limit value setting device may be configured to set said lower limit value so that magnitude of said lower limit value during said all-cylinder operation is smaller than magnitude of said lower limit value during said partial cylinder operation.

When, in order to suppress gear rattle noise, the magnitude of the torque of the second motor-generator is controlled to be greater than or equal to the magnitude of the lower limit value with the differential mechanism being in its non-differential state, then the second motor-generator is in the state of consuming electrical power and the first motor-generator is in the state in which it is not generating electricity. Due to this, if a battery is provided as a source of supply of electrical power to each of the motor-generators, then, since some of the electricity stored in the battery is being consumed in the state that this battery is not being charged, the amount of electricity stored in the battery decreases. Thus, in order to keep down this reduction of the amount of electricity stored in the battery, it is desirable to reduce the amount of consumption of electrical power by keeping down the magnitude of the lower limit value for the torque outputted by the second motor-generator to the lowest possible level. However, when the magnitude of this lower limit value is made to be small, the beneficial effect for suppression of gear rattle noise is deteriorated, since the pressing of the gear against the output unit becomes slackened.

Now, when an engine that is capable of performing both partial cylinder operation and all-cylinder operation is performing partial cylinder operation, the magnitude of the fluctuations in the engine rotational speed is different from their magnitude when the engine is performing all-cylinder operation. Since fluctuations of the engine rotational speed are transmitted as fluctuations of the rotational speed of the output unit, the generation of gear rattle noise and the volume thereof are influenced by the magnitude of the fluctuations of engine rotational speed. The smaller the fluctuations of engine rotational speed are, the more easily gear rattle noise is suppressed, even if the pressing force of the gear against the output unit is small. The fluctuations of engine rotational speed are lower when all-cylinder operation is being performed than when partial cylinder operation is being performed. Thus since, according to the embodiment described above, the magnitude of the lower limit value for the torque of the second motor-generator is set so as to match the magnitude of fluctuations of the engine rotational speed in each of partial cylinder operation and all-cylinder operation, accordingly it is possible to obtain the beneficial effect of suppression of gear rattle noise, while at the same time keeping down the consumption of electrical power by the second motor-generator to the minimum possible limit.

In one embodiment of the control device of the present invention, said vehicle further may comprise a battery that serves as a source of supply of electrical power to said first motor-generator and to said second motor-generator; and said motor control device may be configured to control said second motor-generator so that: when an amount of electricity stored in said battery is high, a positive torque is outputted in a transmission direction from said second motor-generator towards said output unit, having at least magnitude of said lower limit value; and, when an amount of electricity stored in said battery is low, a negative torque is outputted in a transmission direction from said output unit towards said second motor-generator, having at least magnitude of said lower limit value.

When a positive torque is being outputted from the second motor-generator, the gear is in the state of pressing upon the output unit. Conversely, when a negative torque is being outputted from the second motor-generator, the output unit is in the state of pressing upon the gear. In both situations it is possible to suppress gear rattle noise, since backlash is eliminated by holding the gear and the output unit in the state of mutual contact. And, according to the embodiment described above, since when the amount of electricity stored in the battery is high a positive torque is outputted from the second motor-generator and some of the electrical power stored in the battery is being consumed, accordingly a certain clearance of the amount of electricity stored in the battery with respect to its upper limit is brought about. On the other hand, when the amount of electricity stored in the battery is low, a negative torque is outputted from the second motor-generator. In other words, a state is brought about in which it is possible for electricity to be generated from the torque that is inputted to the second motor-generator. Due to this, a certain clearance of the amount of electricity stored in the battery with respect to its lower limit is brought about. Thus, by performing control according to the embodiment described above, it is possible to maintain the state in which certain clearances of the amount of electricity stored in the battery are present with respect to both its upper limit and its lower limit. Accordingly, the latitude with respect to change of the amount of electricity stored in the battery is enhanced.

In one embodiment of the control device of the present invention, said torque lower limit value setting device may be configured to, along with setting as said lower limit value a first value during said partial cylinder operation and a second value during said all-cylinder operation, also, when operation of said engine is changed over between said partial cylinder operation and said all-cylinder operation, change said lower limit value gradually from said first value to said second value, or from said second value to said first value.

When the operation of the engine is changed over between partial cylinder operation and all-cylinder operation, the lower limit value is changed before and after this changeover. When the torque of the second motor-generator is changed by changing the lower limit value, it is possible to satisfy the required drive force by correcting the engine torque. However, because of the fact that during the changeover transition a delay in the response of the engine torque to the correction command takes place, there is a possibility that an excess or a shortage of output to the required drive force may occur and that a shock may be generated. However since, according to the embodiment described above, the lower limit value for the torque of the second motor-generator is changed gradually when the operation of the engine is changed over, accordingly it is possible to soften the change of the torque of the second motor-generator. Thus it is possible to suppress the generation of shock during the transition in which the operation of the engine is changed over.

In one embodiment of the control device of the present invention, said torque lower limit value setting device may be configured to set said lower limit value so as to be changed according to a parameter that exerts an influence upon gear rattle noise generated between said output unit and said gear. By setting the lower limit value according to a parameter that exerts an influence upon gear rattle noise, it becomes possible to reduce the lower limit value to the minimum possible limit. Due to this, it is possible to keep down the consumption of electrical power by the generator and the motor yet further.

### BRIEF DESCRIPTION OF THE DRAWINGS

FIG. 1 shows the overall structure of a vehicle to which a control device according to an embodiment of the present invention is applied;

FIG. 2 is a figure for explanation of an operating point of an engine during hybrid mode;

FIG. 3 is a figure showing the relationship of engine torque and motor torque with respect to required drive force;

FIG. 4 is a time chart showing changing over of engine operating mode and change of a lower limit value for motor torque;

FIG. 5 is a flow chart showing an example of a control routine according to an embodiment of the present invention; and

FIG. 6 is a time chart showing an example of a way in which the lower limit value for motor torque is gradually changed.

### DESCRIPTION OF THE EMBODIMENTS

### Embodiment #1

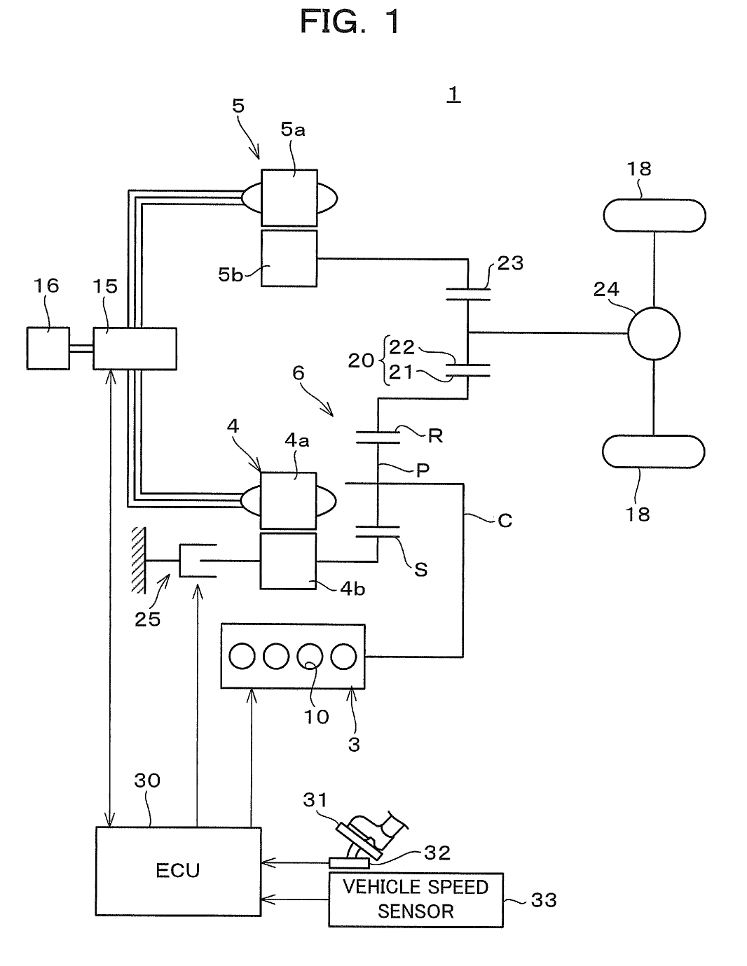

As shown in FIG. 1, a vehicle 1 is built as a hybrid vehicle in which a plurality of power sources are combined. The vehicle 1 comprises an engine 3 and two motor-generators 4 and 5 that serve as sources for driving. The engine 3 is built as an internal combustion engine of the four cylinder in-line type having four cylinders 10. The engine 3 is able to execute all-cylinder operation in which all of the four cylinders 10 operate, and also partial cylinder operation in which two of the four cylinders 10 are inactivated and the remaining two operate.

The engine 3 and the first motor-generator 4 are linked to a power split mechanism 6 that functions as a differential mechanism. The first motor-generator 4 has a stator 4a and a rotor 4b. The first motor-generator 4 both functions as a generator that receives the power of the engine 3 after distribution by the power split mechanism 6 and generates electricity, and also functions as an electric motor that is driven by AC electrical power. In a similar manner, the second motor-generator 5 has a stator 5a and a rotor 5b, and functions both as an electric motor and as a generator. Both of the motor-generators 4 and 5 are connected to a battery 16 via a motor control device 15. The motor control device 15 converts power generated by the motor-generators 4 and 5 into DC power that charges into the battery 16, and also converts power from the battery 16 into AC power that supplies to the motor-generators 4 and 5.

The power split mechanism 6 is built as a single pinion type planetary gear mechanism. This power split mechanism 6 comprises a sun gear S that is an external gear, a ring gear R that is disposed coaxially with the sun gear S and is an internal gear, and a planet carrier C that supports a pinion P meshed with these gears S and R so that the pinion rotates and revolve. The engine torque outputted by the engine 3 is transmitted to the planet carrier C of the power split mechanism 6. The rotor 4b of the first motor-generator 4 is linked to the sun gear S of the power split mechanism 6. And torque outputted from the power split mechanism 6 via its ring gear R is transmitted to an output gear train 20. The output gear train 20 functions as an output unit for transmitting torque to drive wheels 18. And the output gear train 20 comprises an output drive gear 21 that rotates together with the ring gear R of the power split mechanism 6, and an output driven gear 22 that is meshed with this output drive gear 21. The second motor-generator 5 is linked to this output driven gear 22 via a gear 23. The gear 23 thus rotates together with the rotor 5b of the second motor-generator 5. And torque outputted from the output driven gear 22 is distributed via a differential device 24 to the left and right drive wheels 18.

A motor locking mechanism 25 as locking device is provided to the power split mechanism 6. This motor locking mechanism 25 can change over the state of the power split mechanism 6 between a differentiating state in which it distributes the torque of the engine 3 to the first motor-generator 4 and to the output gear train 20, and a non-differential state in which it ceases this distribution. The motor locking mechanism 25 is built as a wet type multi-plate brake mechanism. This motor locking mechanism 25 is changed over between an engaged state in which it prevents rotation of the rotor 4b of the first motor-generator 4, and a released state in which it permits rotation of the rotor 4b. Changing over of the motor locking mechanism 25 between its engaged state and its released state is implemented with a hydraulic actuator not shown in the drawings. When the motor locking mechanism 25 is actuated to be in its engaged state, rotation of the rotor 4b of the first motor-generator 4 is prevented. Due to this, rotation of the sun gear S of the power split mechanism 6 is also prevented. And, due to this, distribution of torque of the engine 2 to the first motor-generator 4 is stopped, and the power split mechanism 6 is put into its non-differential state.

Control of various units of the vehicle 1 is performed by an electronic control device 30 (i.e. an ECU). The ECU 30 performs various types of control for the engine 3, the motor-generators 4 and 5, and the motor locking mechanism 25 and so on. In the following, the principal control that the ECU 30 performs in relation to the present invention will be explained. Various types of information related to the vehicle 1 are inputted to the ECU 30. For example, the rotational speeds and torque of the motor-generators 4 and 5 are inputted to the ECU 30 via the motor control device 15. Moreover, the output signal of an accelerator opening amount sensor 32 that outputs a signal corresponding to the amount by which an accelerator pedal 31 is stepped upon, and the output signal of a vehicle speed sensor 33 that outputs a signal corresponding to the speed of the vehicle 1, are both inputted to the ECU 30. The ECU 30 refers to the output signal of the accelerator opening amount sensor 32 and to the output signal of the vehicle speed sensor 33 and calculates the required drive force that is being demanded by the driver, and controls the vehicle 1 while changing over between various modes, so as to bring the system efficiency for this required drive force to optimum. For example, in a low load region in which the thermal efficiency of the engine 3 decreases, an EV mode may be selected in which combustion of fuel by the engine 3 is stopped and the second motor-generator 5 is driven. Moreover, if the torque provided by the internal combustion engine 3 is insufficient by itself, then a hybrid mode may be selected in which, along with the engine 3, the second motor-generator 5 is also used as a source of drive power for driving. In this case, the required drive force is outputted as the combined sum of the engine torque from the engine 3 and the motor torque from the second motor-generator 5. In other words, if the engine torque is termed Te and the motor torque is termed Tm, then the required drive force Td is defined by Td=Te+Tm.

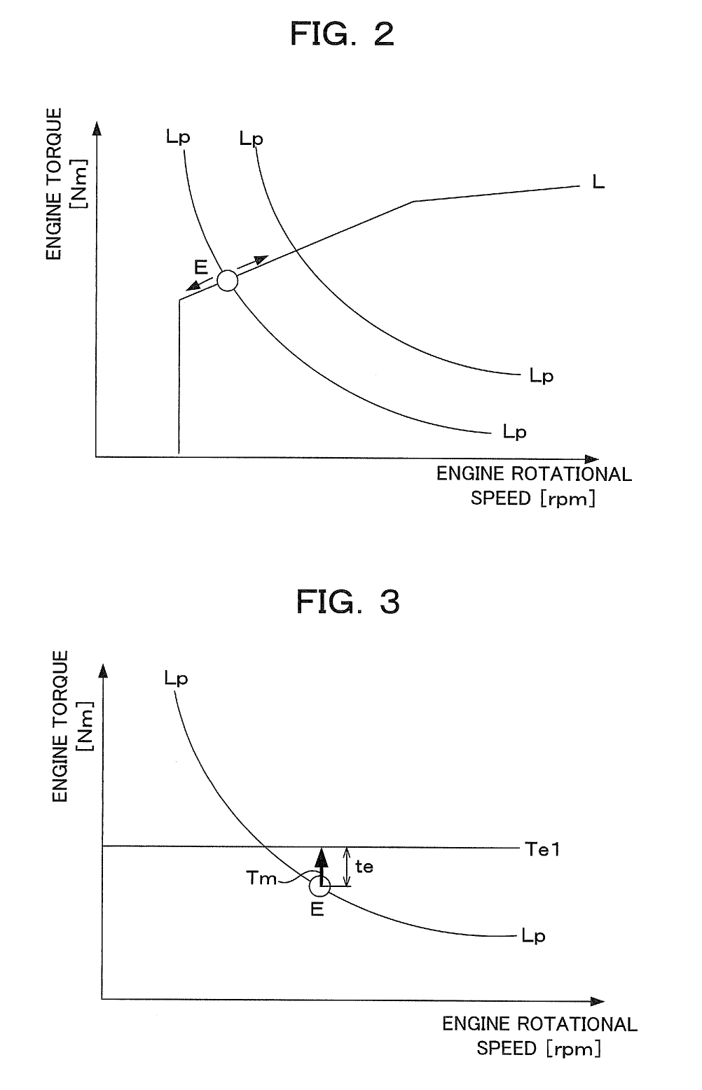

When the hybrid mode is selected, according to the situation, the ECU 30 changes over operational mode between the differential operating mode in which the power split mechanism 6 is put in the differential state and some of the power of the engine 3 is divided off and is used for generation of electricity by the first motor-generator 4, and the non-differential operating mode in which allocation of some of the power of the engine 3 to the first motor-generator 4 is stopped by changing over the state of the power split mechanism 6 to the non-differential state by operating the motor locking mechanism 25, so that all of the power of the engine 3 is outputted to the output gear train 20. As shown in FIG. 2, during the differential operating mode, the engine 3 is controlled by the ECU 30 so that its operating point E that is defined by the engine rotational speed and the engine torque is shifted upon a normal line L that is set in advance. The curves Lp that intersect the normal line L are lines of equal power. The normal line L is determined in advance by simulation or by experiment using a real engine, so that the fuel consumption of the engine 3 becomes optimum and moreover so that it is possible to reduce noise.

On the other hand, changing over to the non-differential operating mode is implemented when, for example, the first motor-generator 4 exceeds its permitted limit temperature and becomes hot, or when it is necessary to avoid so called power circulation in which the rotation of the first motor-generator 4 would be reversed if operation were to be performed in the differential operating mode, or the like. During the non-differential operating mode, the engine rotational speed and the vehicle speed are in a one-to-one relationship. Due to this, it is not possible to control the operating point of the engine 3 to be upon the normal line L, as in the differential operating mode, without subjecting the vehicle speed to limitation.

The control in this embodiment is distinguished by the control performed by the ECU 30 during the non-differential operating mode. As described above, for outputting the required drive force as the combined sum of engine torque and motor torque, it would be possible to cover all of the required drive force with only engine torque. However since, during the non-differential operating mode, fluctuations of the rotational speed of the engine 3 are transmitted as fluctuations of the rotational speed of the output gear train 20, accordingly, when the magnitude of the motor torque of the second motor-generator 5 is small, portions of the teeth of these gears 22 and 23 clash together in a backlash between the output driven gear 22 of the output gear train 20 and the gear 23, and gear rattle noise is generated. Thus, in order to suppress this gear rattle noise, the ECU 30 sets a lower limit value for the motor torque, and controls the second motor-generator 5 so that the torque outputted by the second motor-generator 5 attains at least the magnitude of this lower limit value. Or, to put it in another manner, during the non-differential operating mode, the ECU 30 provides the required drive force, not by covering all of the required drive force with engine torque, but by outputting a torque having at least magnitude of the lower limit value from the second motor-generator 5. In other words, as shown in FIG. 3, during the non-differential operating mode, the ECU 30 controls the engine 3 so that the operating point E of the engine 3 is positioned more towards the low torque side than the engine torque Te1 for fully implementing the required drive force. And it controls the second motor-generator 5 is controlled so that the resulting shortage te below that engine torque Te1 is supplemented by the motor torque Tm.

Since the first motor-generator 4 does not generate any electricity during the non-differential operating mode, accordingly the charging/discharging balance is not proportioned, and the amount of electricity stored in the battery 16 gradually decreases. Thus, in order to suppress decrease of the amount of electricity stored in the battery 16, it is desirable to make the motor torque outputted by the second motor-generator 5 be as small as possible. As described above, the engine 3 can perform either all-cylinder operation or partial cylinder operation. The engine 3 performing all-cylinder operation is different from the engine 3 performing partial cylinder operation in the output characteristics. Since combustion in some of the cylinders 10 is inactivated during partial cylinder operation, accordingly, while if the required drive force is low the fuel consumption is improved over the case when all cylinder operation is being performed, on the other hand fluctuations of the engine torque and fluctuations of the engine rotational speed are greater as compared to the case of all-cylinder operation. The lower the fluctuations of the engine rotational speed are, the lower is the motor torque at which is it possible to suppress gear rattle noise. Accordingly, the minimum motor torque of the second motor-generator 5 that is needed in order to suppress gear rattle noise is smaller during all-cylinder operation as compared to during partial cylinder operation. Due to this, in each of all-cylinder operation and partial cylinder operation, the ECU 30 sets a lower limit value for motor torque that is matched to the output characteristics. In other words, the ECU 30 sets the magnitude of the lower limit value for motor torque during all-cylinder operation to be smaller than the magnitude of the lower limit value for motor torque during partial cylinder operation.

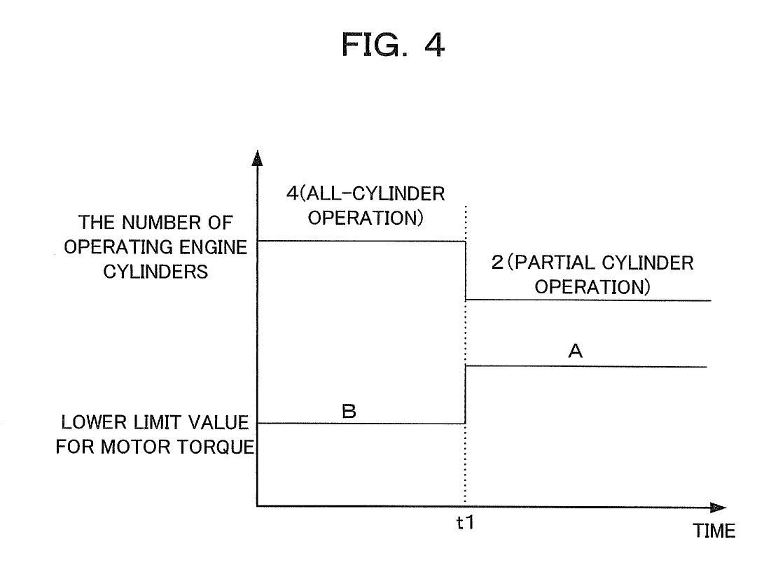

For example when, as shown in FIG. 4, in the non-differential operating mode the operating mode of the engine 3 is changed over from all-cylinder operation to partial cylinder operation at the time point t1, at this time point the ECU 30 changes over the lower limit value for motor torque from B whose magnitude is relatively small to A whose magnitude is relatively large. Since, due to this, both in partial cylinder operation and in all-cylinder operation, the lower limit value for motor torque is set so as to be matched to the magnitude of the fluctuations of engine rotational speed, accordingly it is possible to obtain the beneficial effect of suppressing gear rattle noise, while at the same time keeping down the amount of electrical power consumed by the second motor-generator to the lowest possible limit.

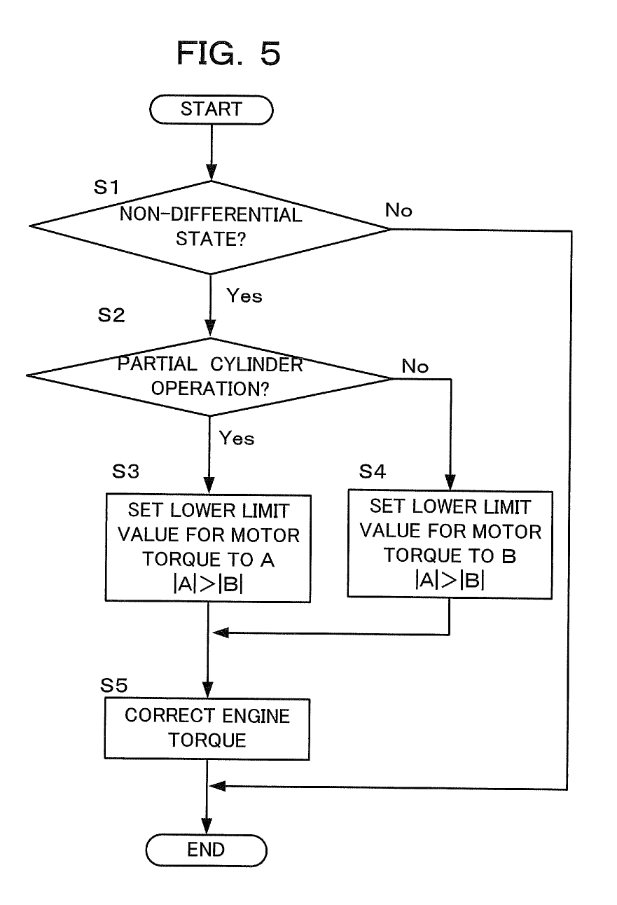

Next, an example of a control routine that is executed by the ECU 30 will be explained with reference to FIG. 5. A program for the control routine of FIG. 5 is stored in the ECU 30, and is read out at an appropriate timing and is repeatedly executed at predetermined intervals. In step S1, the ECU 30 makes a decision as to whether or not the power split mechanism 6 is in its non-differential state, in other words as to whether or not the first motor-generator 4 is being locked by the motor locking mechanism 25. If the mechanism 6 is in the non-differential state then the flow of control proceeds to step S2, while if the mechanism 6 is not in the non-differential state then the flow of control skips the subsequent processing and this cycle of the routine terminates.

In step S2, the ECU 30 makes a decision as to whether or not the current operating mode of the engine 3 is partial cylinder operation. If the engine 3 is currently operating in the partial cylinder mode, then the flow of control proceeds to step S3. But if the engine 3 is not currently operating in the partial cylinder mode, in other words in the case of all-cylinder operation, then the flow of control is transferred to step S4.

In step S3, the ECU 30 sets the lower limit value for motor torque for the second motor-generator 5 to A. And in the step S4 the ECU 30 sets the lower limit value for motor torque for the second motor-generator 5 to B. The magnitude of A is greater than that of B. By executing these steps S3 and S4, the ECU 30 provides the function of the torque lower limit value setting means according to the present invention. While both A and B may be fixed values, it would also be acceptable for them to be changed according to the situation, provided that the magnitude relationship of their absolute values, in other words of their magnitudes, is preserved. It should be understood that in some cases positive motor torque is transmitted in the direction from the second motor-generator 5 to the output gear train 20, while in some cases negative motor torque is transmitted in the direction from the output gear train 20 to the second motor-generator 5. Accordingly, each of A and B can have either a positive value or a negative value.

In step S5, the ECU 30 corrects the engine torque of the engine 3 on the basis of the lower limit value for motor torque. This correction is performed by using the following Equation #1, in which the lower limit value for motor torque is denoted by Tm, the engine torque after correction is denoted by Te, the required drive force is denoted by Td, and the gear ratio of the gears 22 and 23 is denoted by ρ:

Te=Td−(Tm×ρ) #1

By the ECU 30 correcting the engine torque as described above and controlling each of the engine 3 and the second motor-generator 5 so as to satisfy the required drive force, a torque having at least magnitude of the lower limit value is outputted from the second motor-generator 5. Due to this, the ECU 30 provides the function of the motor control device according to the present invention.

By executing the control routine of FIG. 5, the ECU 30 is able to provide the beneficial effect of suppressing gear rattle noise while keeping the amount of electrical power consumed by the second motor-generator 5 down to the lowest possible limit, since, for both partial cylinder operation and all-cylinder operation, the lower limit value for motor torque is set so as to be matched to the magnitude of the fluctuations of engine rotational speed.

### Embodiment #2

As described above, in some cases the motor torque of the second motor-generator 5 is a positive torque and in some cases it is a negative torque. When a positive torque is being outputted from the second motor-generator 5, the gear 23 is in the state of pressing upon the output driven gear 22. Conversely, when a negative torque is being outputted from the second motor-generator 5, the output driven gear 22 is in the state of pressing upon the gear 23. In both these states it is possible to suppress gear rattle noise, since the backlash is eliminated by keeping the gear 23 and the output driven gear 22 in the mutually contacting state.

This second embodiment is one in which the ECU 30 divides employment of the case in which positive torque is being outputted from the second motor-generator 5, and of the case in which negative torque is being outputted from the second motor-generator 5, according to the amount of electricity that is stored in the battery 16. In concrete terms, the ECU 30 acquires the amount of electricity that is stored in the battery 16 by using a SOC sensor not shown in the drawings. Next, if the amount of stored electricity is higher than a predetermined threshold value, then the ECU 30 controls the motor-generator 5 so that a positive torque having at least magnitude of the lower limit value is outputted. On the other hand, if the amount of stored electricity is less than or equal to the above described threshold value, then the ECU 30 controls the motor-generator 5 so that a negative torque having at least magnitude of the lower limit value is outputted. And setting of the lower limit value for motor torque and correction of the engine torque are performed in a similar manner to the case in the first embodiment described above. In other words, during all-cylinder operation, the magnitude of the lower limit value is set to a smaller value as compared to the magnitude of the lower limit value during partial cylinder operation, and the engine torque is corrected on the basis of this lower limit value that has been set. It should be understood that, in this second embodiment, it is desirable to change the motor torque gradually according to a predetermined time rate of change, in order to suppress shock when the motor torque changes from a positive torque to a negative torque, or from a negative torque to a positive torque. By implementing the above described form of control, the ECU 30 provides the function of the motor control device according to the present invention.

Since, according to this second embodiment, when the amount of electricity stored in the battery 16 is high, a positive torque is outputted from the second motor-generator 5 and the electrical power in the battery is gradually consumed, accordingly a certain clearance of the amount of electricity stored in the battery 16 appears with respect to its upper limit. On the other hand, when the amount of electricity stored in the battery 16 is low, a negative torque is outputted from the second motor-generator 5. In other words, a torque is inputted to the second motor-generator 5, and the second motor-generator 5 becomes capable of generating electricity. Due to this, a certain clearance of the amount of electricity stored in the battery 16 appears with respect to its lower limit. Thus, by performing control according to this second embodiment, it is possible to keep the amount of electricity stored in the battery 16 in a state in which it has a certain clearance with respect to both its upper limit and its lower limit. Accordingly, the latitude available for change of the amount of electricity stored in the battery 16 is improved.

### Embodiment #3

This third embodiment is distinguished by the feature that, when the lower limit value for motor torque is changed, this lower limit value is changed gradually. When the torque of the second motor-generator 5 has changed due to change of the lower limit value for motor torque, it is possible to satisfy the required drive force by correcting the engine torque. However, during the transition period of the changeover, there is a possibility that, due to delay that occurs in the response to the correction command for engine torque, an excess or a shortage of output for the required drive force occurs, so that a shock is generated. Thus, during the transition for changeover of operating mode between all-cylinder operation and partial cylinder operation, the ECU 30 changes the lower limit value for motor torque gradually.

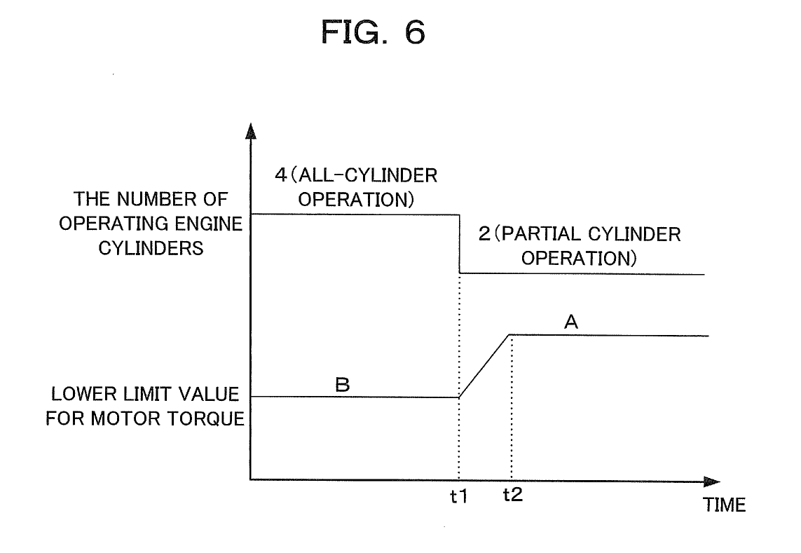

For example if, at the time instant t1, as shown in FIG. 6, the operation of the engine 3 is changed over from all-cylinder operation to partial cylinder operation, then the ECU 30 gradually increases the lower limit value for motor torque from B which is its second value to A which is its first value, over the interval between the time instant t1 and the time instant t2. It should be understood that if the changeover takes place in the opposite direction, in a similar manner, the ECU 30 gradually decreases the lower limit value for motor torque from A to B over a predetermined interval.

Since, according to this third embodiment, the lower limit value for motor torque is gradually changed when the operating state of the engine 3 is changed over, accordingly it is possible to mitigate changes of the torque of the second motor-generator 5. Thus, when changing over the operating state of the engine 3, it is possible to suppress the occurrence of shock during the transition.

The present invention should not be considered as being limited to the embodiments described above; various different embodiments may be implemented within the scope of the present invention. The feature that the lower limit value for motor torque is made different between in the case of all-cylinder operation and in the case of partial cylinder operation is only shown by way of example. It would also be acceptable to arrange to suppress gear rattle noise by setting the same lower limit value for the case of all-cylinder operation and for the case of partial cylinder operation. Moreover, the engine to which the present invention is applied is not limited to being an engine that is capable of performing both all-cylinder operation and partial cylinder operation. If the present invention is applied to an engine of a conventional type, then it is sufficient to set only one lower limit value for motor torque. Even in such a case in which only one lower limit value is set, it would still be possible, in combination with the second embodiment, to use properly either positive torque or negative torque according to the amount of electricity stored in the battery.

Gear rattle noise gets an influence from various parameters, such as the engine water temperature, the temperature of the transmission oil, the vehicle speed, the engine rotational speed, and so on. Thus, it is also possible to change the lower limit value according to the value of one or more parameters that exert influence upon gear rattle noise. Since it is possible to reduce the lower limit value to its lowest possible limit by setting the lower limit value according to a parameter that influences gear rattle noise, accordingly it is possible further to reduce the amount of electrical power consumed by the second motor-generator.

In the various embodiments described above, the power split mechanism 6, which served as a differential mechanism, was changed over from the differential state to the non-differential state by locking the first motor-generator 4 with the motor locking mechanism 25. However, the locking device for changing over the differential mechanism from the differential state to the non-differential state is not limited to being one that prevents the rotation of the first motor-generator itself. For example, it would also be possible to cut off the power transmission path from the differential mechanism to the first motor-generator with a clutch and to implement a locking device that fixes some component on the side of the differential mechanism, thus changing over the differential mechanism from the differential state to the non-differential state with this locking device.

1. A control device for a hybrid vehicle comprising:
an engine;
a first motor-generator;
an output unit for transmitting torque to drive wheels;
a differential mechanism that distributes torque of said engine to said first motor-generator and to said output unit;
a locking device that is capable of changing over a state of said differential mechanism from a differential state in which the torque of said engine is distributed to said first motor-generator and to said output unit, to a non-differential state in which this distribution is stopped; and
a second motor-generator that is linked to said output unit via a gear, the control device comprising:
a torque lower limit value setting device configured to, when said differential mechanism is in said non-differential state, set a lower limit value for torque to be outputted by said second motor-generator; and
a motor control device configured to, when said differential mechanism is in said non-differential state, control said second motor-generator so that magnitude of the torque outputted by said second motor-generator becomes greater than or equal to magnitude of said lower limit value:
wherein said engine has a plurality of cylinders, and is configured to perform partial cylinder operation in which some of said plurality of cylinders are inactive while the remaining ones of said plurality of cylinders operate, and all-cylinder operation in which all of said plurality of cylinders operate;
said the control device further comprises an engine control device configured to cause said engine to execute either said partial cylinder operation or said all-cylinder operation; and
wherein said torque lower limit value setting device is configured to set said lower limit value so that magnitude of said lower limit value during said all-cylinder operation is smaller than magnitude of said lower limit value during said partial cylinder operation.

2. (canceled)

3. The control device for a hybrid vehicle according to claim 1, wherein:
said vehicle further comprises a battery that serves as a source of supply of electrical power to said first motor-generator and to said second motor-generator; and
said motor control device is configured to control said second motor-generator so that: when an amount of electricity stored in said battery is high, a positive torque is outputted in a transmission direction from said second motor-generator towards said output unit, having at least magnitude of said lower limit value; and, when an amount of electricity stored in said battery is low, a negative torque is outputted in a transmission direction from said output unit towards said second motor-generator, having at least magnitude of said lower limit value.

4. The control device for a hybrid vehicle according to claim 1, wherein said torque lower limit value setting device is configured to, along with setting as said lower limit value a first value during said partial cylinder operation and a second value during said all-cylinder operation, also, when operation of said engine is changed over between said partial cylinder operation and said all-cylinder operation, change said lower limit value gradually from said first value to said second value, or from said second value to said first value.

5. The control device for a hybrid vehicle according to claim 1, wherein said torque lower limit value setting device is configured to set said lower limit value so as to be changed according to a parameter that exerts an influence upon gear rattle noise generated between said output unit and said gear.

6. A control device for a hybrid vehicle comprising:
an engine;
a first motor-generator;
an output unit for transmitting torque to drive wheels;
a differential mechanism that distributes torque of said engine to said first motor-generator and to said output unit;
a locking device that is capable of changing over a state of said differential mechanism from a differential state in which the torque of said engine is distributed to said first motor-generator and to said output unit, to a non-differential state in which this distribution is stopped; and
a second motor-generator that is linked to said output unit via a gear, wherein
said engine has a plurality of cylinders; and is configured to perform partial cylinder operation in which some of said plurality of cylinders are inactive while the remaining ones of said plurality of cylinders operate, and all-cylinder operation in which all of said plurality of cylinders operate, and
said control device further comprises an engine control device is configured to cause said engine to execute either said partial cylinder operation or said all-cylinder operation; and said control device is configured to control said second motor-generator so that magnitude of said lower limit value during said all-cylinder operation is smaller than magnitude of said lower limit value during said partial cylinder operation.
